(19) United States
(12) Patent Application Publication
(10) Pub. No.: US 2025/0086467 A1
(43) Pub. Date: Mar. 13, 2025

(54) METADATA DRIVEN PROMPT GROUNDING FOR GENERATIVE ARTIFICIAL INTELLIGENCE APPLICATIONS

(71) Applicant: Salesforce, Inc., San Francisco, CA (US)

(72) Inventors: Victor Yee, San Francisco, CA (US); Yiqiao Liu, Bellevue, WA (US); Shashank Harinath, Palo Alto, CA (US); Fermin Ordaz, San Francisco, CA (US); Adam Smith, Carmel, IN (US); Suhail Barot, Palo Alto, CA (US); Tuan Nguyen, San Francisco, CA (US)

(21) Appl. No.: 18/427,304

(22) Filed: Jan. 30, 2024

Related U.S. Application Data
(60) Provisional application No. 63/581,729, filed on Sep. 11, 2023.

(51) Int. Cl. G06N 3/0895; G06N 3/0475

(52) U.S. Cl. CPC G06N 3/0895; G06N 3/0475

(57) ABSTRACT

The described method may include receiving user input indicating a configuration identifying a large language model (LLM) and a subset of documents indicated in the configuration as being available to a tenant. The method may include generating one or more vectorizations of content of the subset of documents. The method may include receiving a request to generate a generative response. The method may include generating the generative artificial intelligence (AI) prompt using the content to ground the generative AI prompt. The subset of documents may be identified based on a comparison between a vectorization of the request and the one or more vectorizations and based at least in part on a determination that a user associated with the tenant is permitted to access the subset of documents. The method may include presenting a response to the generative AI prompt, the response generated by the LLM using the generative AI prompt.

### CROSS REFERENCES

The present application for patent claims priority to U.S. Provisional Patent Application No. 63/581,729 by Lee, entitled “METADATA DRIVEN PROMPT GROUNDING FOR GENERATIVE ARTIFICIAL INTELLIGENCE APPLICATIONS,” filed Sep. 11, 2023, assigned to the assignee hereof, and expressly incorporated by reference herein.

### FIELD OF TECHNOLOGY

The present disclosure relates generally to database systems and data processing, and more specifically to metadata driven prompt grounding for generative artificial intelligence applications.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

In some cloud platform scenarios, the cloud platform, a server, or other device may make use of generative artificial intelligence (AI), such as large language models (LLMs). However, such methods may be improved.

### BRIEF DESCRIPTION OF THE DRAWINGS

FIG. 1 illustrates an example of a grounding generative artificial intelligence prompts for a tenant of a multi-tenant database system that supports metadata driven prompt grounding for generative artificial intelligence applications.

FIG. 2 shows an example of a system that supports metadata driven prompt grounding for generative artificial intelligence applications.

FIG. 3 shows an example of a process flow that supports metadata driven prompt grounding for generative artificial intelligence applications.

FIG. 4 shows an example of a system that supports metadata driven prompt grounding for generative artificial intelligence applications.

FIG. 5 shows an example of a process flow that supports metadata driven prompt grounding for generative artificial intelligence applications.

FIG. 6 shows an example of a process flow that supports metadata driven prompt grounding for generative artificial intelligence applications.

FIG. 7 shows an example of a process flow that supports metadata driven prompt grounding for generative artificial intelligence applications.

FIG. 8 shows a block diagram of an apparatus that supports metadata driven prompt grounding for generative artificial intelligence applications.

FIG. 9 shows a block diagram of an artificial intelligence manager that supports metadata driven prompt grounding for generative artificial intelligence applications.

FIG. 10 shows a diagram of a system including a device that supports metadata driven prompt grounding for generative artificial intelligence applications.

FIGS. 11 and 12 show flowcharts illustrating methods that support metadata driven prompt grounding for generative artificial intelligence applications.

### DETAILED DESCRIPTION

In some computing systems, generative artificial intelligence (AI) applications can create new content (such as text, images, audio, and the like) based on patterns and data extracted from other sources. These applications can be applied across a range of use cases including (but not limited to) text generation, conversational agents, and code generation. For example, generative AI can create human-like text in the form of emails, product descriptions, knowledge articles, summarizations, and so on. Likewise, chatbots and virtual assistants can use generative AI to have natural-sounding conversations with users, answer questions, provide user assistance, etc. Generative AI can also assist software developers by generating code snippets, templates, or entire programs based on specific constraints provided by end-users.

However, current generative AI applications rely heavily on the quality and quantity of available training data, and can amplify biases present in the training data. These applications operate based on patterns learned from the training data, but do not possess genuine knowledge. Thus, if the training data available to a generative AI application is limited or biased, the content returned by the generative AI application may be low-quality or incoherent. For instance, text, images, or other generative AI outputs can sometimes be non-sensical, contradictory, misleading, or false. Additionally, generative AI often struggles to maintain context over longer blocks of text or conversations. These applications may produce responses that seem relevant in isolation, but are actually disconnected from (e.g., irrelevant to) the broader context of the conversation/prompt. Furthermore, many generative AI models are trained on domains or datasets that are somewhat unrelated to the use case(s) at hand. For many widely-used large language models (LLMs), these datasets often encompass the width of the Internet. As such, content generated by these models may appear reasonable in the context of the broader Internet, but may be inaccurate (or incomplete) within a narrower context.

Aspects of the present disclosure support techniques for using organization-specific metadata to “ground” responses and content returned by generative AI applications. As described herein, grounding refers to the processing of making a prompt (e.g., a request or instruction) more specific, clear, and unambiguous so the generative AI application or LLM can generate more accurate and contextually relevant responses. Additionally or alternatively, the process of grounding may include providing the LLM with a corpus of data from which it is to generate the content of a response (as opposed to allowing the LLM to rely on the vast amount of training data to derive the actual content of the response). The process of grounding involves providing additional context or details to inform the LLM's understanding of the requested task/query and/or the universe of information from which the LLM may draw content. Examples of grounding include adding contextual information to the prompt, defining the expected input/output format, instructing the model to avoid certain terminology, etc. Using organization or user-specific metadata for prompt grounding may improve the accuracy, coherence, and consistency of responses provided by generative AI applications.

The techniques described herein include an offline data ingestion phase and a runtime data retrieval phase. During the offline data ingestion phase, a data processing system may extract, transform, and load a user-selected data set into one or more databases to support query-based and token-based queries. During the runtime data retrieval phase, the data processing system may receive a user query and use a combination of search services and LLM providers to generate a contextually relevant response to the user query. More specifically, the data processing system may compare data associated with the user query (such as text from the user query or an embedding of the user query) to one or more token-based or vector-based search indices, identify a set of relevant documents (e.g., articles, posts, or other content), and provide excerpts from the relevant documents to an LLM provider in the form of a prompt. In response to receiving said information from the data processing system, the LLM provider or generative AI application may use the document excerpts (e.g., passages) to formulate a contextually relevant response according to the instructions provided in the prompt. In some examples, the techniques described herein may include user permissions analysis to determine whether a user associated with a tenant is permitted to access data at one or more levels (e.g., an object level, a record level, a document level, a field level, one or more other levels, or any combination thereof). If the user is not permitted to access such data at one or more such levels, the data may not be used to generate the prompt, whereas data to which the user is permitted access at one or more such levels may be used to aid in generation of the prompt.

Aspects of the disclosure are initially described in the context of an environment supporting an on-demand database service. Aspects of the disclosure are then described with reference to systems and process flows. Aspects of the disclosure are further illustrated by and described with reference to apparatus diagrams, system diagrams, and flowcharts that relate to metadata driven prompt grounding for generative artificial intelligence applications.

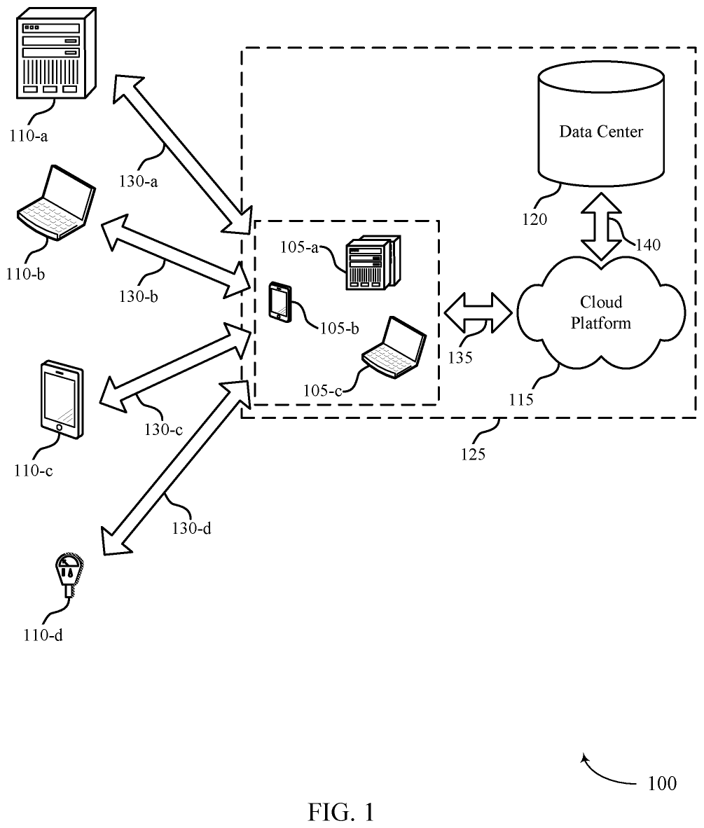

FIG. 1 illustrates an example of a system 100 for cloud computing that supports metadata driven prompt grounding for generative artificial intelligence applications in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

In accordance with the techniques described herein, the cloud platform 115 may pre-process a query received via an interface (e.g., from a cloud client 105) associated with a generative AI service. The cloud platform 115 may use at least one of a first dense vector-based retrieval pipeline, a second dense vector-based retrieval pipeline, or a sparse token-based retrieval pipeline to retrieve (e.g., from the data center 120) a set of documents that pertain to the query. The first dense vector-based retrieval pipeline may include transmitting one or more calls to an LLM gateway that is configured to cause an LLM provider to generate an embedding of the query, and instructing a vector search service to search one or more vector search indices for the set of documents using the embedding generated by the LLM provider. The second dense vector-based retrieval pipeline may include transmitting one or more calls to a model store that is configured to use an imported text embedding model to generate the embedding of the query, and instructing the vector search service to search one or more vector search indices for the set of documents using the embedding generated by the imported text embedding model. The sparse token-based retrieval pipeline may include searching one or more token-based search indices for the set of documents using keywords in the query.

Some approaches to generative AI result in hallucinations, irrelevant data, or other errors being included in generated content (e.g., due to improper or insufficient information being included in a generative AI prompt). Also, other approaches to generative AI do not take advantage of user-specific data, tenant-specific data, organization-specific data, or other entity-specific data, resulting in generated content that is not tailored to the user, tenant, organization, or other entity. Instead, such approaches are highly dependent upon the training data used to train the generative AI system, and may tend to amplify biases found in such data. Further, other approaches also fail to maintain security at more granular levels (e.g., field, record, or object levels) when determining what information to be included in a generative AI prompt. For example, some users may be allowed access to certain information, whereas other users may not. To maintain security of such information, the other users may not be allowed to use such information for grounding generative AI prompts, but other approaches do not account for such security concerns, and sensitive information may be used for generative AI processes inappropriately, resulting in information leakage.

By using organization or user-specific metadata for prompt grounding, the responses generated by the generative AI may improve, such as in terms of accuracy, coherence, and consistency of such responses. Prompts generated in this way may include additional instructions, domain-specific or domain-related knowledge or information, contextual information, input/output formats, “whitelist” language that the generative AI is to use, “blacklist” language that the generative AI is to avoid, or any combination thereof. Further, the access controls to information for generative AI grounding or prompting are detailed at granular levels (e.g., on an object, record, or field level) to promote information security and reduce data leakage to unauthorized parties.

For example, a user associated with a tenant may submit a query to the cloud platform 115 or other system to generate a response to the query using generative AI, such as an LLM. In some examples, the user may authenticate or provide proof of an identity for identify verification or authentication of access to information to be used for grounding the generative AI prompt. The cloud platform 115 may process the query and may leverage metadata (e.g., configured or indicated by an administrator) that indicates documents, files, or information to which the tenant may have access. The cloud platform 115 may have previously indexed or otherwise made record of such documents, files, or information using vectorization or embedding techniques to allow for a comparison between the query and the documents, files, or information to locate relevant portions to be included in a prompt for generative AI. The cloud platform 115 may locate (e.g., based on vectorizations or embeddings associated with the query, the documents, files, or information, or any combination thereof) one or more relevant portions of the documents, files, or information that are to be included in the prompt. Before transmitting the request, the cloud platform 115 may verify whether the user (e.g., based on the user authentication) is permitted access to one or more elements of the relevant portions. The cloud platform 115 may utilize the one or more elements (e.g., objects, records, or fields) of the relevant portions of the documents, files, or information to which the user's access is verified and may generate the prompt using such information. The cloud platform 115 may receive the response generated by the generative AI and may pass the response back to the user.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

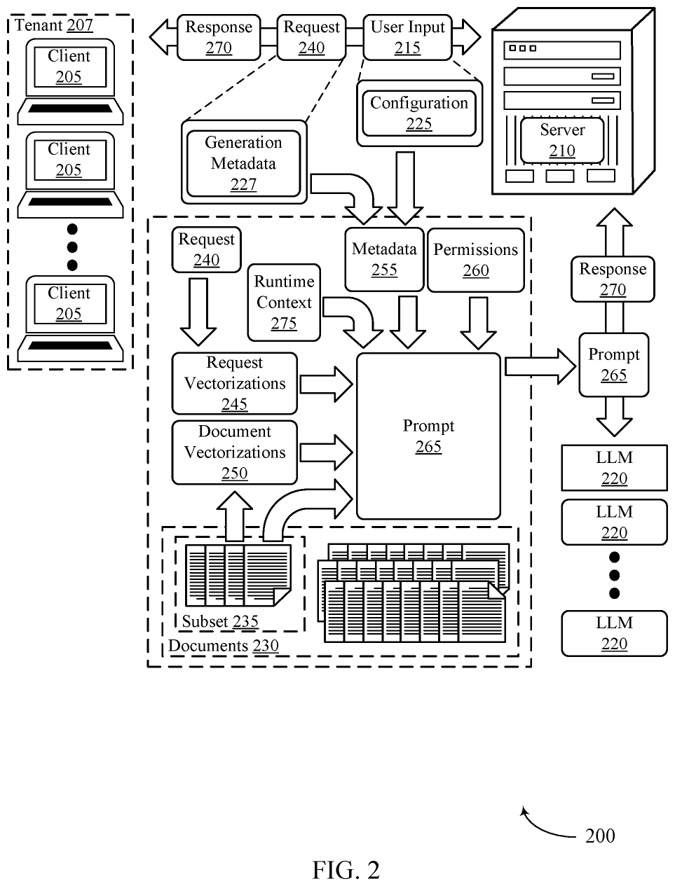

FIG. 2 shows an example of a system 200 that supports metadata driven prompt grounding for generative artificial intelligence applications. The system 200 may implement one or more aspects of the subject matter described herein. The system 200 may include a client 205 (or multiple clients 205) that communicate with a server 210. The clients 205, the server 210, or both, may be associated with a cloud platform. Though certain techniques or operations may be described as being performed by a client 205, the server 210, or other elements, such techniques or operations may be performed by one or more other elements of a cloud platform or that are associated with such a cloud platform.

In some examples, the server 210 may receive the user input 215. The user input 215 may indicate or include one or more elements of a configuration 225 for grounding the prompt 265 (which may be a generative AI prompt). The configuration 225 may indicate or identify an LLM 220 or multiple LLMs 220 that are to generate the response 270 to the prompt 265. The configuration 225 may indicate or identify a subset 235 of documents 230 that are to be used for grounding or otherwise generating the prompt 265. The subset 235 of the documents 230 may be indicated in the configuration 225 as being available to the tenant 207 or to the client 205.

In some examples, the server 210 may generate the document vectorizations 250. The document vectorizations 250 may be vector representations or embeddings of the content of the subset 235 of the documents 230. Such vectorizations may aid in making comparisons between content of the subset 235 of the documents 230, the request 240, one or more other documents or information, or any combination thereof. In some examples, the server 210 may transmit a vectorization request to the LLM 220 or multiple such LLMs 220 to aid in generating the document vectorizations 250. For example, the server 210 may transmit one or more portions of the subset 235 of the documents 230 or an indication of such one or more portions to the LLM 220 for the LLM 220 to process the subset 235 of the documents 230 and generate the document vectorizations 250.

In some examples, the server 210 may receive the request 240 from the client 205. The request 240 may be or include a request for generation of the response 270 using the LLM 220 or multiple such LLMs 220.

In some examples, the server 210 may generate the request vectorizations 245. The request vectorizations 245 may be vector representations or embeddings of the content of the request 240. Such vectorizations may aid in making comparisons between content of the subset 235 of the documents 230, the request 240, one or more other documents or information, or any combination thereof. In some examples, the server 210 may transmit a vectorization request to the LLM 220 or multiple such LLMs 220 to aid in generating the request vectorizations 245. For example, the server 210 may transmit one or more portions of the request 240 or an indication of such one or more portions to the LLM 220 for the LLM 220 to process the request 240 and generate the request vectorizations 245.

In some examples, the server 210 may generate the prompt 265 using the content of the subset 235 of the documents 230, the request vectorizations 245, the document vectorizations 250, or any combination thereof to ground the prompt 265. For example, the server 210 may compare the request vectorizations 245 and the document vectorizations 250 to identify one or more portions of the subset 235 of the documents 230 that may be relevant to the request 240 and are to be used to ground the prompt 265.

In some examples, the server 210 may further determine whether the client 205 is permitted to access the one or more portions of the subset 235 of the documents 230 that were identified for use in grounding the prompt 265. For example, the server 210 may analyze the permissions 260 that may be associated with the client 205 to make such a determination. If the client 205 is permitted to access the one or more portions of the subset 235 of the documents 230, then the server 210 may ground the prompt 265 using the one or more portions. If not, the server 210 may transmit an error message or may continue grounding the prompt 265 using information that the client 205 is permitted to access.

In some examples, the server 210 may then transmit a request to the LLM 220 to generate the response 270 based on the prompt 265 and may present or transmit the response 270 to the client 205. Such a presentation or transmission may be in various forms, such as a message, an indication in a user interface associated with the client 205 or the tenant 207, or any other communication medium.

In some examples, the server 210 may store one or more aspects or indications of the configuration 225 in the metadata 255. In response to receiving the request 240, the server 210 may access the metadata 255 to aid in grounding the prompt 265. For example, the metadata 255 may include the identification or indication of the LLM 220 or multiple LLMs 220 and the subset 235 of the documents 230. In some examples, the metadata 255 may include an indication of one or more records, objects, or fields associated with the subset 235 of the documents 230, an indication of a quantity of documents, records, objects, or fields of the subset 235 of the documents 230 that are to be used for grounding the prompt 265, an indication of a vectorization or embedding model, an indication of one or more specifications, characteristics, or aspects of the subset 235 of the documents 230, or any combination thereof.

In some examples, the server 210 may also include, in the metadata 255, the generation metadata 227. The generation metadata 227 may indicate one or more aspects or elements of the subset 235 of the documents 230, such as one or more objects, records, or fields of the subset 235 of the documents 230 that the server 210 is to use to ground the prompt 265. For example, even though the configuration 225 may indicate the entire subset 235 of the documents 230, the generation metadata 227 may indicate one or more portions of the subset 235 based on the situation, user desire, the runtime context 275, or other additional factors that may influence which portions of the subset 235 are to be used to ground the prompt 265.

In some examples, the runtime context 275 may indicate that the response 270 or a portion thereof is to be used in a customer support context, in an artistic context, or in any other context. This runtime context 275 may be associated with one or more rules for grounding the prompt 265 that may differ for different runtime contexts 275. For example, a customer support context may include different templates, instructions, or other information for generating the response 270 that may not be present in the artistic context.

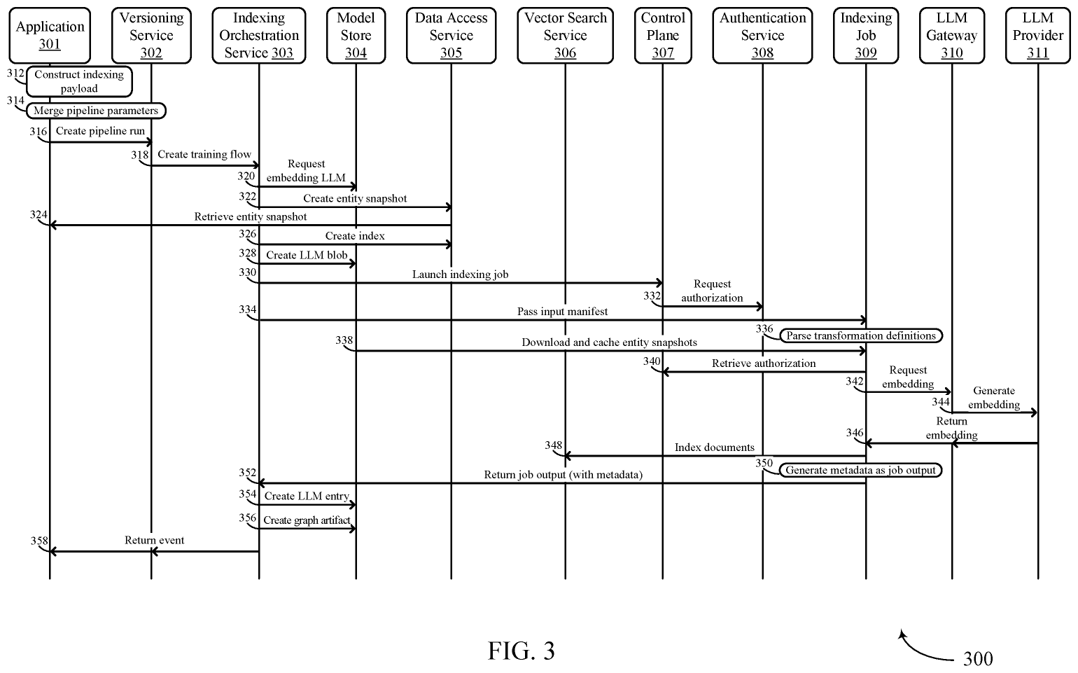

FIG. 3 shows an example of a process flow 300 that supports metadata driven prompt grounding for generative artificial intelligence applications.

As described herein, the operation of a system implementing the subject matter described herein may involve two stages, jobs, or phases. FIG. 3 depicts one example of a first stage, phase or job, which may involve a data ingestion job. Such a job may employ the use of metadata from a frontend interface on what an administrator may wishes to use to ground a given generative AI prompt on. The job may further extract, transform, and load that data to a vector and feature store databases.

In some examples, the application 301 may include or be associated with an interface with which a client of a tenant may interact. The application 301 may be responsible for exposing an administrative user interface allowing a client (e.g., an administrator) to configure the data to be indexed to ground a generative prompt later at runtime.

For example, at 312, the application 301 may be responsible for composing a metadata payload or indexing payload representing the user configuration. In some examples, the metadata payload may include a model provider and model name to be used to generate embeddings or vectorizations. Such an embedding or vectorization may be a numeric representation of a document (e.g., of potentially different content types, such as text, images, audio, or video) that permits semantic retrieval of said document later at runtime. In some examples, the metadata payload may include source dataset specifications, including one or more fields from the source dataset or datasets and how the source dataset or datasets should or should not be filtered or segmented. In some examples, the metadata payload may include an indication of one or more fields to be indexed, including the source dataset(s) and fields to be used as input. In some examples, the metadata payload may include a definition of how this input data should be transformed for indexing. For example, the one or more fields or other information may be concatenated, transformed, combined, split, formatted, or otherwise modified or transformed to aid in vectorization or embedding operations or other operations described herein. For example, even if a database is stored in a first format, such transformations may allow for the use of a different format for use in grounding the prompt. In some examples, at 314, the application 301 may further merge one or more pipeline parameters and, at 316, may call the versioning service 302 to begin the data ingestion pipeline.

In some examples, the versioning service 302 may be used to support processes in a machine learning development lifecycle, including versioning of configurations of both machine learning applications and of individual machine learning pipelines, as well as deployments of configurations for machine learning applications and their associated pipelines. Additionally, or alternatively, the versioning service 302 may store versioned internal metadata, compute configurations, deployment, or any combination thereof associated with machine learning pipelines. In some examples, the versioning service 302 may serve as a unified interface between the application 301 and other elements of a generative AI system by accepting metadata and calls to execute the pipeline, returning a pipeline status (e.g., success or failure), scheduling periodic executions of the pipeline to maintain index freshness, or any combination thereof. For example, at 318, the versioning service 302 may create a training flow that may be used to support indexing or data ingestion that may be used to support grounding of generative AI prompts.

In some examples, the indexing orchestration service 303 may be or include a workflow execution engine that may manage one or more aspects of indexing or data ingestion to support grounding of generative AI prompts. For example, in response to receiving a flow execution call (including a payload containing a merged representation of internal application metadata and external customer configuration), the indexing orchestration service 303 may coordinate one or more calls out to other services (described below). For example, at 320, the indexing orchestration service 303 may request an embedding or vectorization LLM from the model store 304. At 322, the indexing orchestration service 303 may create an entity snapshot of the input source data in association with the data access service 305.

In some examples, the model store 304 may include a binary large object (blob) store, a metadata database including data about one or more blobs in the blob store, or both. In association with the data ingestion or indexing operations, the model store 304 may store metadata associated with LLMs or other models used for embedding documents. Such metadata may point to an external service (e.g., an LLM outside of the cloud platform) or to an internal service (e.g., associated with the cloud platform). Additionally, or alternatively, in association with the data ingestion or indexing operations, the model store 304 may store metadata about the indexing, embedding, vectorization, or any combination thereof created by one or more data ingestion operations. Such metadata may allow the application 301 to correctly locate and query the index for grounding a generative AI prompt. In some examples, at 328, the indexing orchestration service 303 may create an LLM blob at the model store 304.

In some examples, the data access service 305 may be or include a service that allows access to secure data associated with the cloud platform, the tenant, a client, or any combination thereof. In some examples, at 324, the data access service 305 may retrieve a snapshot of the input source data from the application 301, optionally in accordance with the input configuration (e.g., that which may be specified by an administrator or user). In response, at 326, the indexing orchestration service 303 may create an index in association with the data access service 305.

In some examples, the vector search service 306 may be or include a vector database, a vector search engine, or both. In connection with data ingestion or indexing operations, the vector search service 306 may provide an interface for creating, hydrating, and managing the index that may be configured or intended for vector search (e.g., in association with one or more runtime operations).

In some examples, the control plane 307 may be or include a unified interface for submitting and managing computational jobs (e.g., indexing jobs). For example, at 330, the indexing orchestration service 303 may initiate, via the control plane 307, an indexing job, after which the control plane 307 is responsible for executing the indexing job (e.g., in association with one or more calls to one or more other services).

In some examples, the authentication service 308 may be a core service that may support operations of other services. While not all operations may be depicted, the authentication service 308 may be responsible, in association with the other services, to provide isolation of data between different tenants or clients (e.g., in a multi-tenant environment). Additionally, or alternatively, the authentication service 308 may provide enforcement of service scopes such that ingress (inbound) and egress (outbound) calls. For example, such service scopes may be enforced to (1) respect a principal of least responsibility (e.g., in which each service operates on a need-to-know basis) and (2) respect a centralized repository of rules (e.g., for access decisions). For example, at 332 and in association with one or more data ingestion operations, the authentication service 308 may provide authorization (e.g., a JavaScript web token) requested by the control plane 307 in association with one or more indexing operations to authorize calls to the LLM gateway 310. In response, at 334, the indexing orchestration service 303 may pass the input manifest to the indexing job 309 to continue indexing operations.

In some examples, the indexing job 309 may represent or describe a computational process in which the metadata for what to index and the source input data, come together. For example, the indexing job 309 may determine, based on the metadata, which portions of the source input data is to be indexed. The output of such a process may include the hydration of a vector index (e.g., in association with the vector search service 306) that may be queried at runtime to ground a generative AI prompt. In some examples, at 336, the indexing job 309 may parse one or more transformation definitions to be applied to one or more portions of the source data documents. For example, the indexing job 309 may parse vector transforms, which may include transforms such as batching, token count, string processing, truncation, or any combination thereof. The indexing job 309 may parse string transforms, which may include identity operations or concatenation operations. Such transforms (e.g., vector transforms, string transforms, or both), may be performed on one or more portions of the identified, vectorized, or embedded source documents or data to support indexing and eventual use for grounding generative AI prompts. In some examples, at 338, the indexing job 309 may download and cache entity snapshots to aid in the indexing operations. Further, at 340, the indexing job 309 may retrieve one or more authorization elements (e.g., a JavaScript web token) associated with the authentication service 308 to access the LLM to generate the embedding or vectorization.

In some examples, the LLM gateway 310 may be a service that provides a central interface for transforming input media into embeddings) transforming a given prompt into newly-generated text, or any combination thereof. In some examples, in association with data ingestion or indexing operations, the LLM gateway 310 may be responsible for abstracting the implementation of the embedding model, in such a way that embedding can be referenced via metadata. Additionally, or alternatively, the LLM gateway 310 may be responsible for providing a trust layer, including authentication and authorization with underlying services such as with the LLM providers 311. Additionally, or alternatively, the LLM gateway 310 may be responsible for providing a mechanism to track usage for billing and cost-to-serve purposes. For example, at 342, the LLM gateway 310 may receive a request from the indexing job 309 to generate the embedding.

In some examples, the LLM provider 311 may be a publicly-accessible LLM, a privately-accessible LLM, a local LLM, or other LLM used for operations of embedding, vectorization, data ingestion, indexing, or any combination thereof. For example, at 344, the LLM gateway 310 may transmit a request to the LLM providers 311 to generate an embedding or vectorization, and, at 346, the LLM gateway 310 may return the generated embedding or vectorization to the LLM gateway 310, the indexing job 309, or both.

In some examples, at 348, the indexing job 309 may (e.g., in response to receiving the embedding or vectorization) index the one or more documents or portions thereof based on the embedding or vectorization. Further, at 350 the indexing job 309 may generate metadata as the output of the indexing job 309 and the metadata may include information associated with the indexing. At 352, the indexing job 309 may transmit the metadata as the output of the indexing job 309. In response, at 354, the indexing orchestration service 303 may create an LLM entry and, at 356, may create a graph artifact associated with metadata about the created index. In some examples, at 358, the indexing orchestration service 303 may return a platform event to the versioning service 302, the application 301, or both, which may conclude the operations associated with indexing, embedding, vectorization, data ingestion, or any combination thereof.

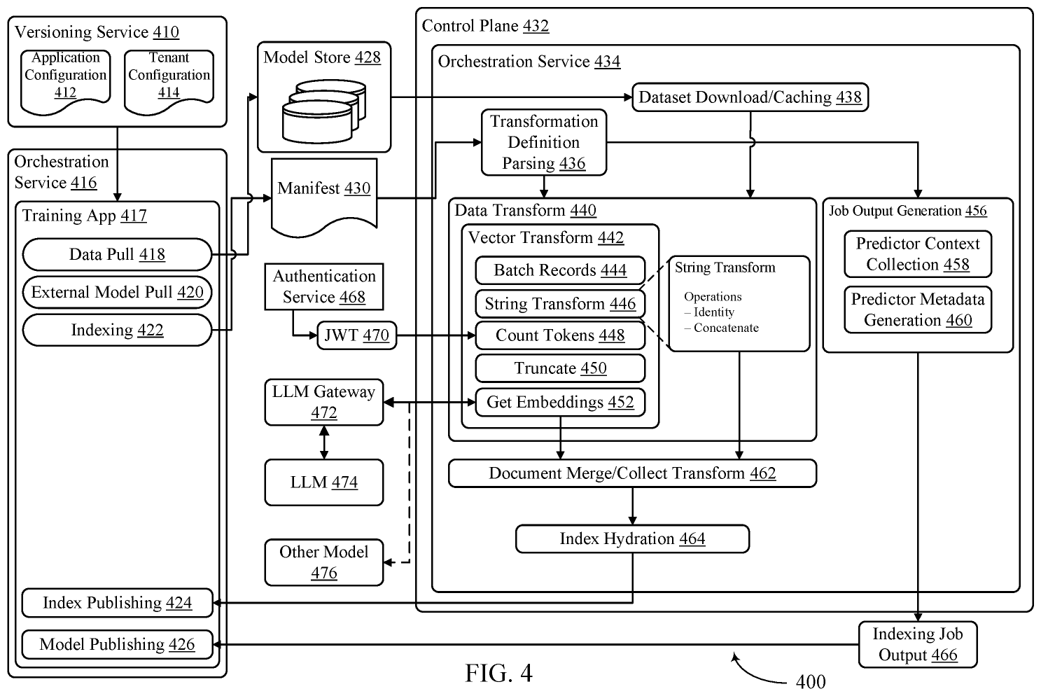

FIG. 4 shows an example of a system 400 that supports metadata driven prompt grounding for generative artificial intelligence applications. In some examples, the processing system 400 may include various services or elements. Though some services or elements are depicted as being associated with some operations, the operations may be performed by one or more other services or elements. The processing system 400 may illustrate examples associated with indexing, embedding, vectorization, data ingestion, or any combination thereof.

In some examples, the versioning service 410 may be associated with versioning of configuration of models and associated pipelines. The versioning service 410 may include or be associated with the application configuration 412 and the tenant configuration 414. The application configuration 412 may include one or more configurations, settings, or information associated with the operation of the application (e.g., such as the application 301). The tenant configuration 414 may include one or more configurations, settings, or information associated with a tenant, which may be specific to that tenant and may differ between tenants. In this way, the processing system 400 may operate differently for different tenants.

In some examples, the orchestration services 416 may be associated with a training app 417. The training app 417 may be associated with training one or more models (e.g., LLMs) or associated pipelines or processes, including the data pull 418, the external model pull 420, and the indexing 422. The data pull 418 may be associated with pulling, identifying, or determining a model (e.g., an LLM 474 or other model 476) from the model store 428 to be used for vectorization/embedding or grounding prompts. In some examples, the indexing 422 may be associated with the actual indexing of the source documents or portions thereof (e.g., having been vectorized or embedded) based on the manifest 430. The manifest 430 may include information, such as metadata, which may be associated with indexing, embedding, vectorization, data ingestion, or any combination thereof. One example of such a manifest 430 may be the metadata 255, the permissions 260, the configuration 225, the generation metadata 227, or any combination thereof.

In some examples, the processing system 400 may include a control plane 432 that may coordinate one or more operations of the processing system 400. The control plane 432 may include or be associated with an orchestration services 434 that may orchestrate one or more operations associated with indexing, embedding, vectorization, data ingestion, or any combination thereof. For example, at the dataset download/caching 438, the orchestration services 434 may download or cache datasets that may be transformed at the data transform 440 based on one or more transformation definitions that may be parsed at 436 (e.g., based on the manifest 430). The data transform 440 may include or be associated with a vector transform 442, which itself may include or be associated with one or more operations, including the batch records 444, the string transform 446, the count tokens 448, the truncate 450 transform, the get embeddings 452. The count tokens 448 may determine whether a JavaScript web token (JWT), such as the JWT 470, has been received from the authentication service 468 that may be used to access the LLM 474 through the LLM gateway 472 or may be used to determine which records, objects, or fields are accessible by the client that may be requesting grounding of the generative AI prompt. In some examples, the string transform 446 may include one or more operations, including an identify operation and a concatenation operation.

In some examples, the vector transform 442 may include a get embeddings 452 operation, which may query the LLM 474 through the LLM gateway 472 to generate one or more embeddings or vectorizations of one or more portions of source data documents that are to be used to ground the generative AI prompts.

In some examples, the orchestration services 434 may perform the document merge/collect transform 462 based on the vector transform 442, the retrieved embeddings, or any combination thereof. In some examples, the orchestration services 434 may further perform the index hydration 464, which may describe an update or inclusion of the information from the source data documents (e.g., a vectorized or embedded representation of such information) into the index.

In some examples, the control plane 432, the orchestration services 434, or any combination thereof, may perform the job output generation 456, which may include performing the predictor context collection 458 (e.g., which may involve analysis of a predictor context associated with the indexing, embedding, vectorization, data ingestion, or any combination thereof), the predictor metadata generation 460 (e.g., which may involve analysis of predictor metadata associated with the indexing, embedding, vectorization, data ingestion, or any combination thereof), or any combination thereof. Ise the job output generation 456 may result in the production of the indexing job output 466.

In some examples, the orchestration services 416, the training app 417, or both may perform the index publishing 424 to publish the index. Additionally, or alternatively, the orchestration services 416, the training app 417, or both may perform the model publishing 426 to publish one or more models to be used for grounding the generative AI prompt.

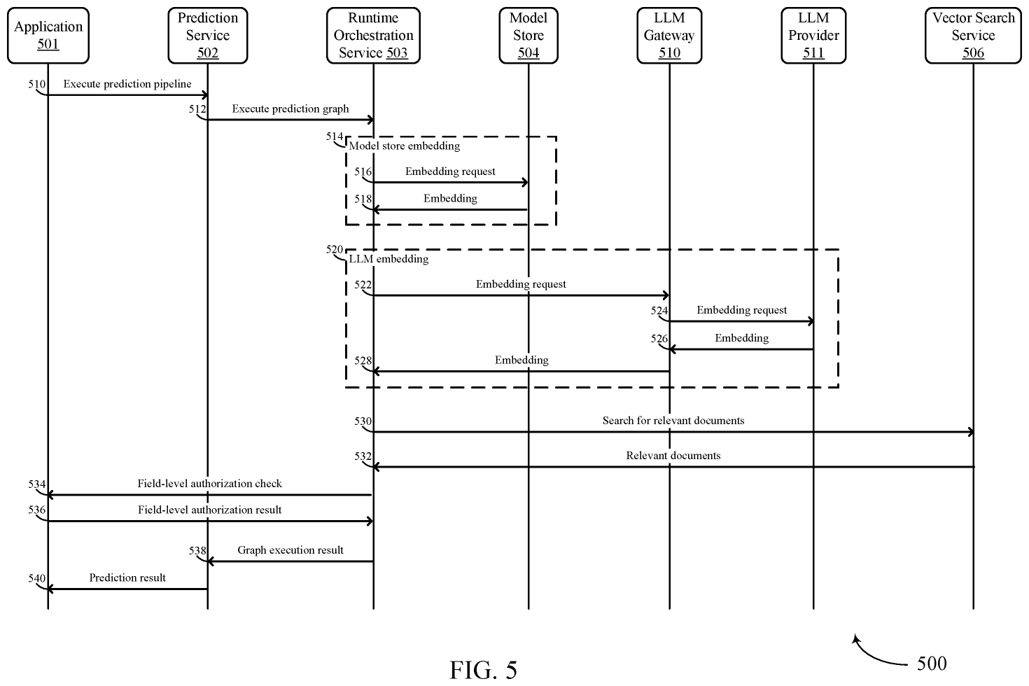

FIG. 5 shows an example of a process flow 500 that supports metadata driven prompt grounding for generative artificial intelligence applications.

As described herein, the operation of a system implementing the subject matter described herein may involve two stages, jobs, or phases. FIG. 5 depicts one example of a second stage, phase or job, which may involve an interface with which a user interacts. This interface may generate new content in real-time given customer input to the generative AI system. For given user input, this interface may first retrieve the most relevant data from the vector or feature databases (e.g., that are populated during the “offline” or data ingestion job), uses this data as context for grounding a prompt for generating a new response, and returns the grounded text as configured by user.

At 510, the application 501 may execute a prediction pipeline, which may trigger the prediction service 502 to execute the prediction graph at 512. As a result, the runtime orchestration service 503 may perform a model store embedding 514, an LLM embedding 520, or any combination thereof. The model store embedding 514 may employ the use of a model internal to the cloud platform, whereas the LLM embedding 520 may employ the use of the LLM provider 511 via the LLM gateway 510.

In the model store embedding 514, the runtime orchestration service 503 may transmit, at 516, an embedding request to the model store 504 (e.g., to vectorize or embed a runtime request to generate a response with an LLM using a grounded prompt), which may respond with the requested embedding 518. Additionally, or alternatively, at the LLM embedding 520, the runtime orchestration service 503 may transmit, at 522, the embedding request to the LLM gateway 510 which may, at 524, transmit the embedding request to the LLM provider 511. At 526, The LLM provider 511 may transmit the generated embedding to the LLM gateway 510 which, at 528, may transmit the embedding to the runtime orchestration service 503.

At 530, the runtime orchestration service 503 may perform the search for relevant documents via the vector search service 506. For example, the runtime orchestration service 503 may compare the received embedding to embeddings retrieved via the vector search service 506 to identify one or more documents or portions thereof that may be relevant for grounding the generative AI prompt. At 532, such relevant documents or portions thereof may be retrieved from the vector search service 506 and received by the runtime orchestration service 503.

In some examples, at 534 after receiving the relevant documents or portions thereof, the runtime orchestration service 503 may perform the field-level authorization check to determine, via the application 501, whether the particular client that requested the generative AI response has access to one or more fields that were determined to be relevant or retrieved at 532. In response to the request transmitted at 534, at 536 the application 501 may transmit the field level authorization result to the runtime orchestration service 503 to inform the runtime orchestration service 503 whether the client or user is permitted to access the information of the relevant documents on a per-field basis. For example, some users or clients may have permission to access certain fields of a document but may not be permitted to access one or more other fields of the same document.

At 538, the runtime orchestration service 503 may graph the execution result and pass it to the prediction service 502, which, at 540, may pass the prediction result to the application 501 for presentation to the user or client. The presentation result may include the information that may be relevant or helpful in grounding the generative AI prompt, which may then be included in the generative AI prompt. The generative AI prompt may then be transmitted to the generative AI (e.g., an LLM) which may process the prompt and return a response, which may then be presented to the user.

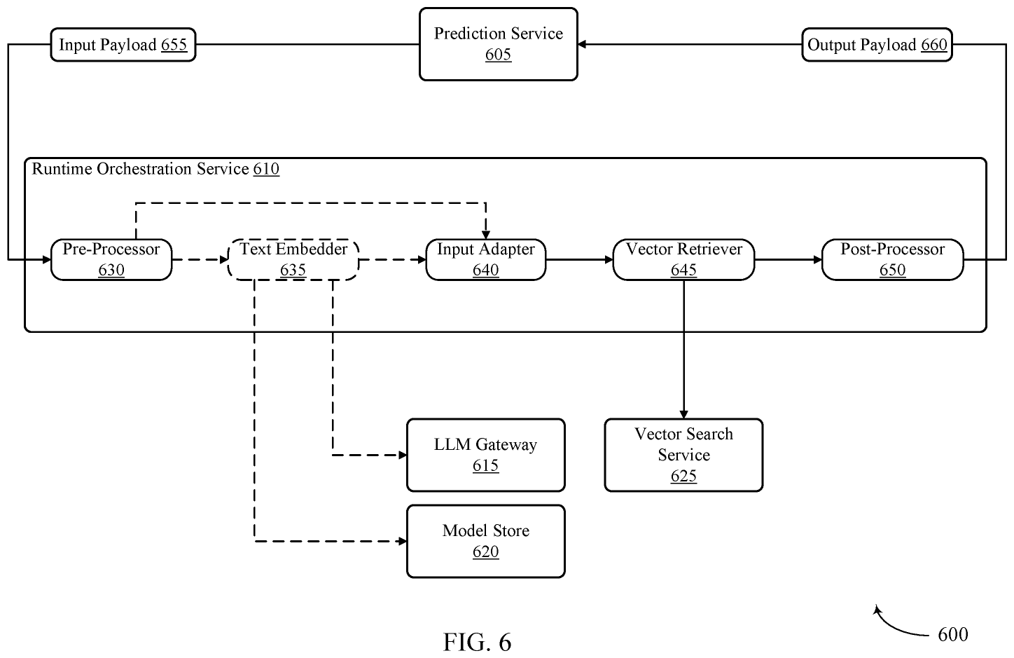

FIG. 6 shows an example of a process flow 600 that supports metadata driven prompt grounding for generative artificial intelligence applications. As described herein, the operation of a system implementing the subject matter described herein may involve two stages, jobs, or phases. FIG. 6 depicts one example of a second stage, phase, job, or runtime pipeline, which includes different options for embedding and retrieval combinations.

In some examples, the prediction service 605 may transmit the input payload 655 to the runtime orchestration service 610. The input payload 655 may include metadata, configurations, requests (e.g., the request 240), other information, or any combination thereof, that may be used by the runtime orchestration service 610 to identify relevant documents or information to be used to ground the generative AI prompt.

The runtime orchestration service 610 may include a pre-processor 630, which may process the input payload 655 for one or more further operations. In some examples, the runtime orchestration service 610 may include a text embedder 635, which may aid in embedding or vectorizing information (e.g., the request 240) for comparison with other embeddings or vectorizations to identify relevant information for ground the generative AI prompt.

In some examples, the text embedder 635 may transform the input payload 655 or a portion thereof into an embedding by calling the embeddings endpoint provided by the LLM gateway 615, which makes additional calls to LLM providers to generate the embedding. Additionally, or alternatively, the text embedder 635 may transform the input payload 655 or a portion thereof into an embedding by querying for the model trained or uploaded to the model store 620 during the data ingestion operations. Additionally, or alternatively, the runtime orchestration service 610 may not employ the text embedder 635 and may directly uses the input payload 655 or a portion thereof to search for the relevant documents or portions thereof.

In some examples, the input adapter 640 may adapt the embeddings or direct information to be utilized by the vector retriever 645, which may query the vector search service 625 to identify, determine, or search for relevant documents in the indices stored in vector databases by the data ingestion operations. In some examples, the post-processor 650 may process the identified documents, portions thereof, or any combination thereof (or indications of such documents or portions thereof) for inclusion in the output payload 660, which may be returned to the prediction service 605 to be used for grounding the generative AI prompt.

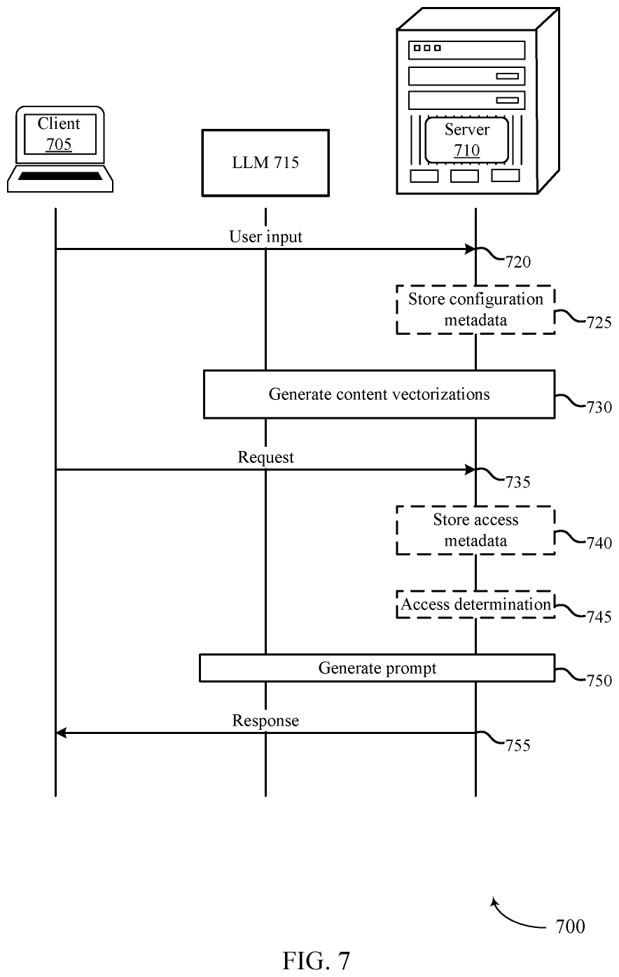

FIG. 7 shows an example of a process flow 700 that supports metadata driven prompt grounding for generative artificial intelligence applications. The process flow 700 may implement various aspects of the present disclosure described herein. The elements described in the process flow 700 (e.g., client 705, application server 710, and one or more LLMs 715) may be examples of similarly named elements described herein.

In the following description of the process flow 700, the operations between the various entities or elements may be performed in different orders or at different times. Some operations may also be left out of the process flow 700, or other operations may be added. Although the various entities or elements are shown performing the operations of the process flow 700, some aspects of some operations may also be performed by other entities or elements of the process flow 700 or by entities or elements that are not depicted in the process flow, or any combination thereof.

At 720, the application server 710 may receive (e.g., from the client 705 or other entity) user input indicating a configuration that identifies one or more large language models (LLMs) configurable for the tenant and an indication of a subset of documents of a set of documents stored at the multi-tenant database system, the subset of documents indicated in the configuration as being available to the tenant for processing with the one or more LLMs 715.

At 725, the application server 710 may store configuration metadata that may include the indication of the one or more LLMs 715 and the indication of the subset of documents. In some examples, the configuration metadata further may include an indication of one or more fields of the subset of documents, an indication of a quantity of the subset of documents whose content is to be vectorized, an indication of a vectorization model, an indication of one or more specifications of the subset of documents, or any combination thereof.

At 730, the application server 710 may generate one or more respective vectorizations of content of each document of the subset of documents. In some examples, generating the one or more respective vectorizations is based on the configuration metadata. In some examples, the application server 710 may transmit, to the one or more LLMs 715, a first vectorization request to generate the one or more respective vectorizations of the content of each document of the subset of documents. In some examples, the application server 710 may receive, from the one or more LLMs 715, the one or more respective vectorizations of the content.

At 735, the application server 710 may receive, from a user associated with the tenant, a request to generate a generative response with the one or more LLMs 715. In some examples, the request may indicate generation metadata indicating one or more fields of the one or more documents of the subset of documents, or any combination thereof.

At 740, the application server 710 may store access metadata comprising an indication of the subset of documents, an indication of one or more fields of the subset of documents, or any combination thereof.

At 745, the application server 710 may query a central authentication service to produce an authentication result indicating that the tenant is permitted to access the one or more of the subset of documents, the one or more fields, or any combination thereof.

At 750, the application server 710 may generate the generative AI prompt using the content of one or more documents of the subset of documents to ground the generative AI prompt and the subset of documents is identified based on a comparison between a vectorization of the request and at least one of the one or more respective vectorizations of the subset of documents and based on a determination that the user associated with the tenant is permitted to access the subset of documents. In some examples, generating the generative AI prompt is based on the configuration metadata. In some examples, generating the generative AI prompt is based on the generation metadata. In some examples, the application server 710 may transmit, to the one or more LLMs 715, a second vectorization request to generate the vectorization of the request. In some examples, the application server 710 may receive, from the one or more LLMs 715, the vectorization of the request. In some examples, generating the generative AI prompt is based on a runtime context associated with the request to generate the generative response.

At 755, the application server 710 may present a response to the generative AI prompt, the response generated by the one or more LLMs 715 using the generative AI prompt. In some examples, presenting the response to the generative AI prompt is based on the authentication result. The process flow 700 may implement various aspects of the present disclosure described herein. The elements described in the process flow 700 (e.g., client 705, application server 710, and one or more LLMs 715) may be examples of similarly named elements described herein.

In the following description of the process flow 700, the operations between the various entities or elements may be performed in different orders or at different times. Some operations may also be left out of the process flow 700, or other operations may be added. Although the various entities or elements are shown performing the operations of the process flow 700, some aspects of some operations may also be performed by other entities or elements of the process flow 700 or by entities or elements that are not depicted in the process flow, or any combination thereof.

At 720, the application server 710 may receive (e.g., from the client 705 or other entity) user input indicating a configuration that identifies one or more large language models (LLMs) configurable for the tenant and an indication of a subset of documents of a set of documents stored at the multi-tenant database system, the subset of documents indicated in the configuration as being available to the tenant for processing with the one or more LLMs 715.

At 725, the application server 710 may store configuration metadata that may include the indication of the one or more LLMs 715 and the indication of the subset of documents. In some examples, the configuration metadata further may include an indication of one or more fields of the subset of documents, an indication of a quantity of the subset of documents whose content is to be vectorized, an indication of a vectorization model, an indication of one or more specifications of the subset of documents, or any combination thereof.

At 730, the application server 710 may generate one or more respective vectorizations of content of each document of the subset of documents. In some examples, generating the one or more respective vectorizations is based on the configuration metadata. In some examples, the application server 710 may transmit, to the one or more LLMs 715, a first vectorization request to generate the one or more respective vectorizations of the content of each document of the subset of documents. In some examples, the application server 710 may receive, from the one or more LLMs 715, the one or more respective vectorizations of the content.

At 735, the application server 710 may receive, from a user associated with the tenant, a request to generate a generative response with the one or more LLMs 715. In some examples, the request may indicate generation metadata indicating one or more fields of the one or more documents of the subset of documents, or any combination thereof.

At 740, the application server 710 may store access metadata comprising an indication of the subset of documents, an indication of one or more fields of the subset of documents, or any combination thereof.

At 745, the application server 710 may query a central authentication service to produce an authentication result indicating that the tenant is permitted to access the one or more of the subset of documents, the one or more fields, or any combination thereof.

At 750, the application server 710 may generate the generative AI prompt using the content of one or more documents of the subset of documents to ground the generative AI prompt and the subset of documents is identified based on a comparison between a vectorization of the request and at least one of the one or more respective vectorizations of the subset of documents and based on a determination that the user associated with the tenant is permitted to access the subset of documents. In some examples, generating the generative AI prompt is based on the configuration metadata. In some examples, generating the generative AI prompt is based on the generation metadata. In some examples, the application server 710 may transmit, to the one or more LLMs 715, a second vectorization request to generate the vectorization of the request. In some examples, the application server 710 may receive, from the one or more LLMs 715, the vectorization of the request. In some examples, generating the generative AI prompt is based on a runtime context associated with the request to generate the generative response.

At 755, the application server 710 may present a response to the generative AI prompt, the response generated by the one or more LLMs 715 using the generative AI prompt. In some examples, presenting the response to the generative AI prompt is based on the authentication result.

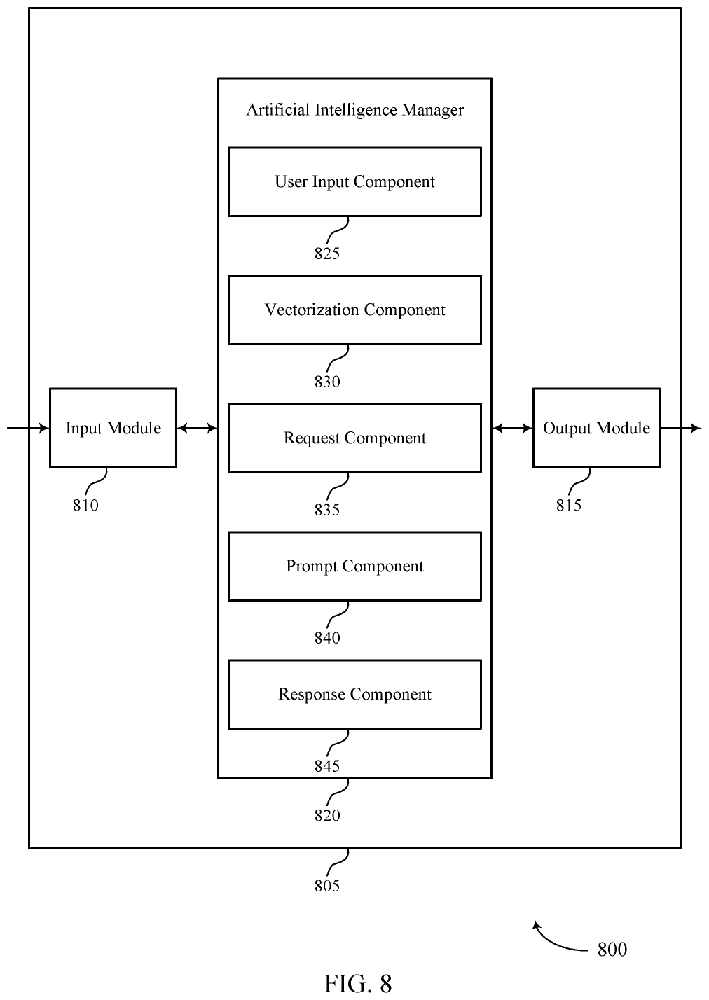

FIG. 8 shows a block diagram 800 of a device 805 that supports metadata driven prompt grounding for generative artificial intelligence applications. The device 805 may include an input module 810, an output module 815, and an artificial intelligence manager 820. The device 805, or one of more components of the device 805 (e.g., the input module 810, the output module 815, the artificial intelligence manager 820), may include at least one processor, which may be coupled with at least one memory, to support the described techniques. Each of these components may be in communication with one another (e.g., via one or more buses).

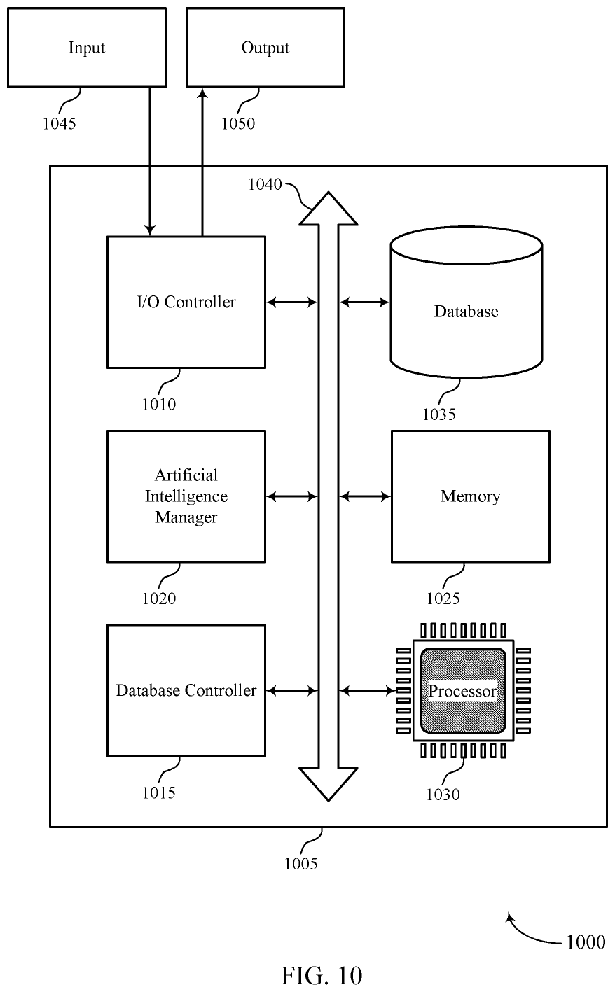

The input module 810 may manage input signals for the device 805. For example, the input module 810 may identify input signals based on an interaction with a modem, a keyboard, a mouse, a touchscreen, or a similar device. These input signals may be associated with user input or processing at other components or devices. In some cases, the input module 810 may utilize an operating system such as iOS®, ANDROID®, MS-DOS®, MS-WINDOWS®, OS/2®, UNIX®, LINUX®, or another known operating system to handle input signals. The input module 810 may send aspects of these input signals to other components of the device 805 for processing. For example, the input module 810 may transmit input signals to the artificial intelligence manager 820 to support metadata driven prompt grounding for generative artificial intelligence applications. In some cases, the input module 810 may be a component of an input/output (I/O) controller 1010 as described with reference to FIG. 10.

The output module 815 may manage output signals for the device 805. For example, the output module 815 may receive signals from other components of the device 805, such as the artificial intelligence manager 820, and may transmit these signals to other components or devices. In some examples, the output module 815 may transmit output signals for display in a user interface, for storage in a database or data store, for further processing at a server or server cluster, or for any other processes at any number of devices or systems. In some cases, the output module 815 may be a component of an I/O controller 1010 as described with reference to FIG. 10.

For example, the artificial intelligence manager 820 may include a user input component 825, a vectorization component 830, a request component 835, a prompt component 840, a response component 845, or any combination thereof. In some examples, the artificial intelligence manager 820, or various components thereof, may be configured to perform various operations (e.g., receiving, monitoring, transmitting) using or otherwise in cooperation with the input module 810, the output module 815, or both. For example, the artificial intelligence manager 820 may receive information from the input module 810, send information to the output module 815, or be integrated in combination with the input module 810, the output module 815, or both to receive information, transmit information, or perform various other operations as described herein.

The artificial intelligence manager 820 may support grounding a generative artificial intelligence (AI) prompt for a tenant of a multi-tenant database system in accordance with examples as disclosed herein. The user input component 825 may be configured to support receiving user input indicating a configuration that identifies one or more large language models (LLMs) configurable for the tenant and an indication of a subset of documents of a set of documents stored at the multi-tenant database system, the subset of documents indicated in the configuration as being available to the tenant for processing with the one or more LLMs. The vectorization component 830 may be configured to support generating one or more respective vectorizations of content of each document of the subset of documents. The request component 835 may be configured to support receiving, from a user associated with the tenant, a request to generate a generative response with the one or more LLMs. The prompt component 840 may be configured to support generating the generative AI prompt using the content of one or more documents of the subset of documents to ground the generative AI prompt, where the subset of documents is identified based on a comparison between a vectorization of the request and at least one of the one or more respective vectorizations of the subset of documents and based on a determination that the user associated with the tenant is permitted to access the subset of documents. The response component 845 may be configured to support presenting a response to the generative AI prompt, the response generated by the one or more LLMs using the generative AI prompt.

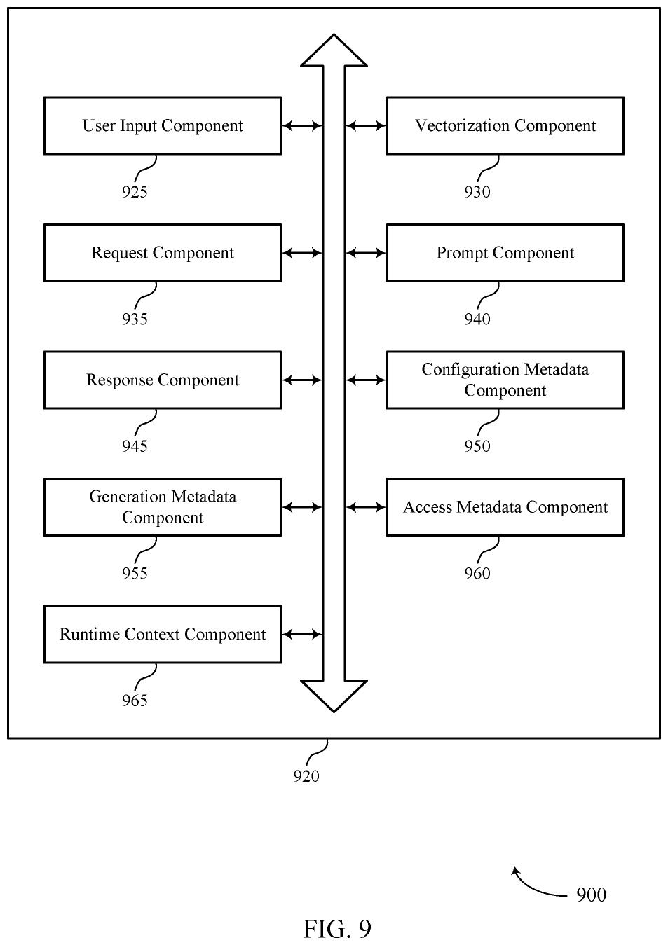

FIG. 9 shows a block diagram 900 of an artificial intelligence manager 920 that supports metadata driven prompt grounding for generative artificial intelligence applications. The artificial intelligence manager 920 may be an example of aspects of an artificial intelligence manager or an artificial intelligence manager 820, or both, as described herein. The artificial intelligence manager 920, or various components thereof, may be an example of means for performing various aspects of metadata driven prompt grounding for generative artificial intelligence applications as described herein. For example, the artificial intelligence manager 920 may include a user input component 925, a vectorization component 930, a request component 935, a prompt component 940, a response component 945, a configuration metadata component 950, a generation metadata component 955, an access metadata component 960, a runtime context component 965, or any combination thereof. Each of these components, or components of subcomponents thereof (e.g., one or more processors, one or more memories), may communicate, directly or indirectly, with one another (e.g., via one or more buses).

The artificial intelligence manager 920 may support grounding a generative artificial intelligence (AI) prompt for a tenant of a multi-tenant database system in accordance with examples as disclosed herein. The user input component 925 may be configured to support receiving user input indicating a configuration that identifies one or more large language models (LLMs) configurable for the tenant and an indication of a subset of documents of a set of documents stored at the multi-tenant database system, the subset of documents indicated in the configuration as being available to the tenant for processing with the one or more LLMs. The vectorization component 930 may be configured to support generating one or more respective vectorizations of content of each document of the subset of documents. The request component 935 may be configured to support receiving, from a user associated with the tenant, a request to generate a generative response with the one or more LLMs. The prompt component 940 may be configured to support generating the generative AI prompt using the content of one or more documents of the subset of documents to ground the generative AI prompt, where the subset of documents is identified based on a comparison between a vectorization of the request and at least one of the one or more respective vectorizations of the subset of documents and based on a determination that the user associated with the tenant is permitted to access the subset of documents. The response component 945 may be configured to support presenting a response to the generative AI prompt, the response generated by the one or more LLMs using the generative AI prompt.

In some examples, the configuration metadata component 950 may be configured to support storing configuration metadata including the indication of the one or more LLMs and the indication of the subset of documents. In some examples, the configuration metadata component 950 may be configured to support where generating the one or more respective vectorizations is based on the configuration metadata. In some examples, the configuration metadata component 950 may be configured to support where generating the generative AI prompt is based on the configuration metadata.

In some examples, the configuration metadata further includes an indication of one or more fields of the subset of documents, an indication of a quantity of the subset of documents whose content is to be vectorized, an indication of a vectorization model, an indication of one or more specifications of the subset of documents, or any combination thereof.

In some examples, the request indicates generation metadata indicating one or more fields of the one or more documents of the subset of documents, or any combination thereof. In some examples, generating the generative AI prompt is based on the generation metadata.

In some examples, to support generating the one or more respective vectorizations of content, the vectorization component 930 may be configured to support transmitting, to the one or more LLMs, a first vectorization request to generate the one or more respective vectorizations of the content of each document of the subset of documents. In some examples, to support generating the one or more respective vectorizations of content, the vectorization component 930 may be configured to support receiving, from the one or more LLMs, the one or more respective vectorizations of the content.

In some examples, to support generating the generative AI prompt, the vectorization component 930 may be configured to support transmitting, to the one or more LLMs, a second vectorization request to generate the vectorization of the request. In some examples, to support generating the generative AI prompt, the vectorization component 930 may be configured to support receiving, from the one or more LLMs, the vectorization of the request.

In some examples, the access metadata component 960 may be configured to support storing access metadata including an indication of the subset of documents, an indication of one or more fields of the subset of documents, or any combination thereof. In some examples, the access metadata component 960 may be configured to support querying a central authentication service to produce an authentication result indicating that the tenant is permitted to access the one or more of the subset of documents, the one or more fields, or any combination thereof. In some examples, the access metadata component 960 may be configured to support where presenting the response to the generative AI prompt is based on the authentication result.

In some examples, generating the generative AI prompt is based on a runtime context associated with the request to generate the generative response.

FIG. 10 shows a diagram of a system 1000 including a device 1005 that supports metadata driven prompt grounding for generative artificial intelligence applications. The device 1005 may be an example of or include components of a device 805 as described herein. The device 1005 may include components for bi-directional data communications including components for transmitting and receiving communications, such as an artificial intelligence manager 1020, an I/O controller, such as an I/O controller 1010, a database controller 1015, at least one memory 1025, at least one processor 1030, and a database 1035. These components may be in electronic communication or otherwise coupled (e.g., operatively, communicatively, functionally, electronically, electrically) via one or more buses (e.g., a bus 1040).

The I/O controller 1010 may manage input signals 1045 and output signals 1050 for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. In other cases, the I/O controller 1010 may represent or interact with a modem, a keyboard, a mouse, a touchscreen, or a similar device. In some cases, the I/O controller 1010 may be implemented as part of a processor 1030. In some examples, a user may interact with the device 1005 via the I/O controller 1010 or via hardware components controlled by the I/O controller 1010.

The database controller 1015 may manage data storage and processing in a database 1035. In some cases, a user may interact with the database controller 1015. In other cases, the database controller 1015 may operate automatically without user interaction. The database 1035 may be an example of a single database, a distributed database, multiple distributed databases, a data store, a data lake, or an emergency backup database.

Memory 1025 may include random-access memory (RAM) and read-only memory (ROM). The memory 1025 may store computer-readable, computer-executable software including instructions that, when executed, cause at least one processor 1030 to perform various functions described herein. In some cases, the memory 1025 may contain, among other things, a basic I/O system (BIOS) which may control basic hardware or software operation such as the interaction with peripheral components or devices. The memory 1025 may be an example of a single memory or multiple memories. For example, the device 1005 may include one or more memories 1025.

The processor 1030 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 1030 may be configured to operate a memory array using a memory controller. In other cases, a memory controller may be integrated into the processor 1030. The processor 1030 may be configured to execute computer-readable instructions stored in at least one memory 1025 to perform various functions (e.g., functions or tasks supporting metadata driven prompt grounding for generative artificial intelligence applications). The processor 1030 may be an example of a single processor or multiple processors. For example, the device 1005 may include one or more processors 1030.

The artificial intelligence manager 1020 may support grounding a generative artificial intelligence (AI) prompt for a tenant of a multi-tenant database system in accordance with examples as disclosed herein. For example, the artificial intelligence manager 1020 may be configured to support receiving user input indicating a configuration that identifies one or more large language models (LLMs) configurable for the tenant and an indication of a subset of documents of a set of documents stored at the multi-tenant database system, the subset of documents indicated in the configuration as being available to the tenant for processing with the one or more LLMs. The artificial intelligence manager 1020 may be configured to support generating one or more respective vectorizations of content of each document of the subset of documents. The artificial intelligence manager 1020 may be configured to support receiving, from a user associated with the tenant, a request to generate a generative response with the one or more LLMs. The artificial intelligence manager 1020 may be configured to support generating the generative AI prompt using the content of one or more documents of the subset of documents to ground the generative AI prompt, where the subset of documents is identified based on a comparison between a vectorization of the request and at least one of the one or more respective vectorizations of the subset of documents and based on a determination that the user associated with the tenant is permitted to access the subset of documents. The artificial intelligence manager 1020 may be configured to support presenting a response to the generative AI prompt, the response generated by the one or more LLMs using the generative AI prompt.

By including or configuring the artificial intelligence manager 1020 in accordance with examples as described herein, the device 1005 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

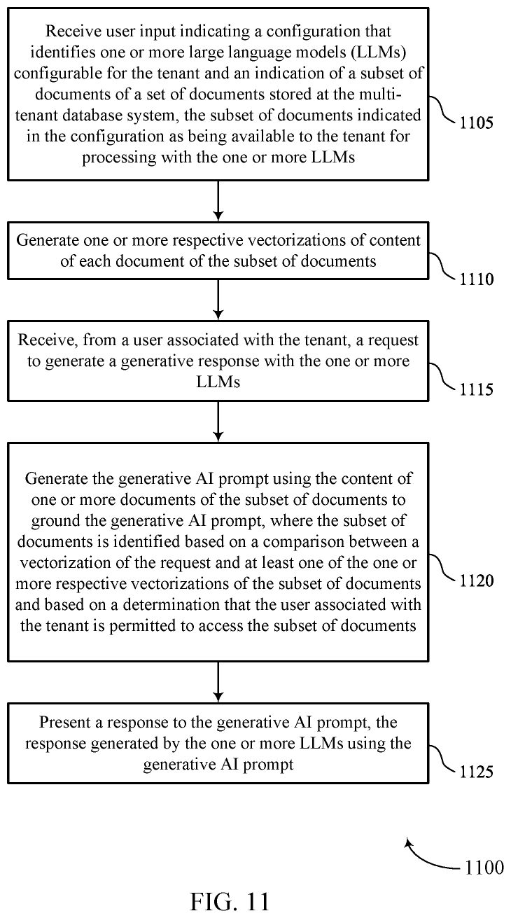

FIG. 11 shows a flowchart illustrating a method 1100 that supports metadata driven prompt grounding for generative artificial intelligence applications. The operations of the method 1100 may be implemented by an application server or its components as described herein. For example, the operations of the method 1100 may be performed by an application server as described with reference to FIGS. 1 through 10. In some examples, an application server may execute a set of instructions to control the functional elements of the application server to perform the described functions. Additionally, or alternatively, the application server may perform aspects of the described functions using special-purpose hardware.

At 1105, the method may include receiving user input indicating a configuration that identifies one or more large language models (LLMs) configurable for the tenant and an indication of a subset of documents of a set of documents stored at the multi-tenant database system, the subset of documents indicated in the configuration as being available to the tenant for processing with the one or more LLMs. The operations of 1105 may be performed in accordance with examples as disclosed herein. In some examples, aspects of the operations of 1105 may be performed by a user input component 925 as described with reference to FIG. 9.

At 1110, the method may include generating one or more respective vectorizations of content of each document of the subset of documents. The operations of 1110 may be performed in accordance with examples as disclosed herein. In some examples, aspects of the operations of 1110 may be performed by a vectorization component 930 as described with reference to FIG. 9.

At 1115, the method may include receiving, from a user associated with the tenant, a request to generate a generative response with the one or more LLMs. The operations of 1115 may be performed in accordance with examples as disclosed herein. In some examples, aspects of the operations of 1115 may be performed by a request component 935 as described with reference to FIG. 9.

At 1120, the method may include generating the generative AI prompt using the content of one or more documents of the subset of documents to ground the generative AI prompt, where the subset of documents is identified based on a comparison between a vectorization of the request and at least one of the one or more respective vectorizations of the subset of documents and based on a determination that the user associated with the tenant is permitted to access the subset of documents. The operations of 1120 may be performed in accordance with examples as disclosed herein. In some examples, aspects of the operations of 1120 may be performed by a prompt component 940 as described with reference to FIG. 9.

At 1125, the method may include presenting a response to the generative AI prompt, the response generated by the one or more LLMs using the generative AI prompt. The operations of 1125 may be performed in accordance with examples as disclosed herein. In some examples, aspects of the operations of 1125 may be performed by a response component 945 as described with reference to FIG. 9.

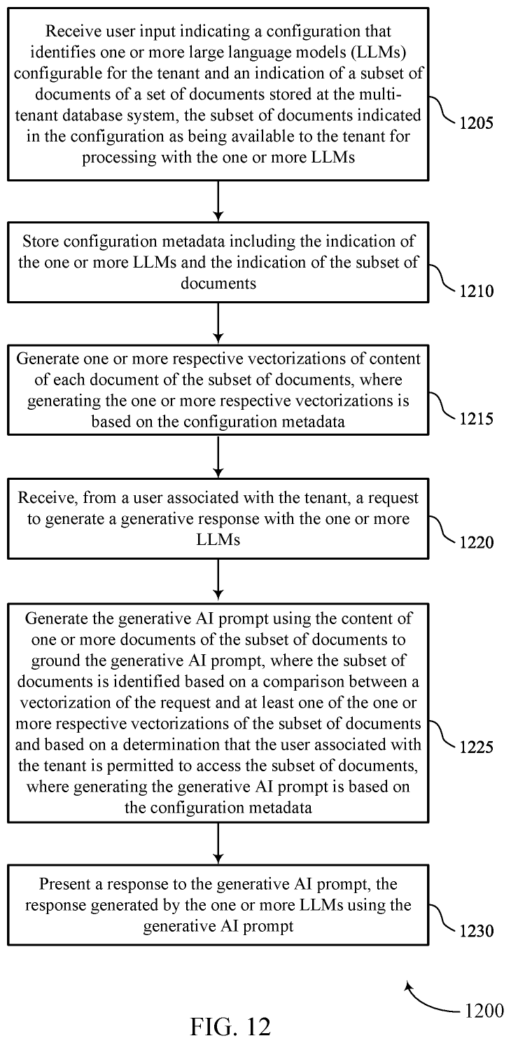

FIG. 12 shows a flowchart illustrating a method 1200 that supports metadata driven prompt grounding for generative artificial intelligence applications. The operations of the method 1200 may be implemented by an application server or its components as described herein. For example, the operations of the method 1200 may be performed by an application server as described with reference to FIGS. 1 through 10. In some examples, an application server may execute a set of instructions to control the functional elements of the application server to perform the described functions. Additionally, or alternatively, the application server may perform aspects of the described functions using special-purpose hardware.

At 1205, the method may include receiving user input indicating a configuration that identifies one or more large language models (LLMs) configurable for the tenant and an indication of a subset of documents of a set of documents stored at the multi-tenant database system, the subset of documents indicated in the configuration as being available to the tenant for processing with the one or more LLMs. The operations of 1205 may be performed in accordance with examples as disclosed herein. In some examples, aspects of the operations of 1205 may be performed by a user input component 925 as described with reference to FIG. 9.

At 1210, the method may include storing configuration metadata including the indication of the one or more LLMs and the indication of the subset of documents. The operations of 1210 may be performed in accordance with examples as disclosed herein. In some examples, aspects of the operations of 1210 may be performed by a configuration metadata component 950 as described with reference to FIG. 9.

At 1215, the method may include generating one or more respective vectorizations of content of each document of the subset of documents, where generating the one or more respective vectorizations is based on the configuration metadata. The operations of 1215 may be performed in accordance with examples as disclosed herein. In some examples, aspects of the operations of 1215 may be performed by a vectorization component 930 as described with reference to FIG. 9, a configuration metadata component 950 as described with reference to FIG. 9, or any combination thereof.

At 1220, the method may include receiving, from a user associated with the tenant, a request to generate a generative response with the one or more LLMs. The operations of 1225 may be performed in accordance with examples as disclosed herein. In some examples, aspects of the operations of 1225 may be performed by a request component 935 as described with reference to FIG. 9.

At 1225, the method may include generating the generative AI prompt using the content of one or more documents of the subset of documents to ground the generative AI prompt, where the subset of documents is identified based on a comparison between a vectorization of the request and at least one of the one or more respective vectorizations of the subset of documents and based on a determination that the user associated with the tenant is permitted to access the subset of documents, where generating the generative AI prompt is based on the configuration metadata. The operations of 1230 may be performed in accordance with examples as disclosed herein. In some examples, aspects of the operations of 1230 may be performed by a prompt component 940 as described with reference to FIG. 9, a configuration metadata component 950 as described with reference to FIG. 9, or any combination thereof.

At 1230, the method may include presenting a response to the generative AI prompt, the response generated by the one or more LLMs using the generative AI prompt. The operations of 1240 may be performed in accordance with examples as disclosed herein. In some examples, aspects of the operations of 1240 may be performed by a response component 945 as described with reference to FIG. 9.

A method for grounding a generative artificial intelligence (AI) prompt for a tenant of a multi-tenant database system by an apparatus is described. The method may include receiving user input indicating a configuration that identifies one or more large language models (LLMs) configurable for the tenant and an indication of a subset of documents of a set of documents stored at the multi-tenant database system, the subset of documents indicated in the configuration as being available to the tenant for processing with the one or more LLMs, generating one or more respective vectorizations of content of each document of the subset of documents, receiving, from a user associated with the tenant, a request to generate a generative response with the one or more LLMs, generating the generative AI prompt using the content of one or more documents of the subset of documents to ground the generative AI prompt, where the subset of documents is identified based on a comparison between a vectorization of the request and at least one of the one or more respective vectorizations of the subset of documents and based on a determination that the user associated with the tenant is permitted to access the subset of documents, and presenting a response to the generative AI prompt, the response generated by the one or more LLMs using the generative AI prompt.

An apparatus for grounding a generative artificial intelligence (AI) prompt for a tenant of a multi-tenant database system is described. The apparatus may include one or more memories storing processor executable code, and one or more processors coupled with the one or more memories. The one or more processors may individually or collectively be operable to execute the code to cause the apparatus to receive user input indicating a configuration that identifies one or more large language models (LLMs) configurable for the tenant and an indication of a subset of documents of a set of documents stored at the multi-tenant database system, the subset of documents indicated in the configuration as being available to the tenant for processing with the one or more LLMs, generate one or more respective vectorizations of content of each document of the subset of documents, receive, from a user associated with the tenant, a request to generate a generative response with the one or more LLMs, generate the generative AI prompt using the content of one or more documents of the subset of documents to ground the generative AI prompt, where the subset of documents is identified based on a comparison between a vectorization of the request and at least one of the one or more respective vectorizations of the subset of documents and based on a determination that the user associated with the tenant is permitted to access the subset of documents, and present a response to the generative AI prompt, the response generated by the one or more LLMs using the generative AI prompt.

Another apparatus for grounding a generative artificial intelligence (AI) prompt for a tenant of a multi-tenant database system is described. The apparatus may include means for receiving user input indicating a configuration that identifies one or more large language models (LLMs) configurable for the tenant and an indication of a subset of documents of a set of documents stored at the multi-tenant database system, the subset of documents indicated in the configuration as being available to the tenant for processing with the one or more LLMs, means for generating one or more respective vectorizations of content of each document of the subset of documents, means for receiving, from a user associated with the tenant, a request to generate a generative response with the one or more LLMs, means for generating the generative AI prompt using the content of one or more documents of the subset of documents to ground the generative AI prompt, where the subset of documents is identified based on a comparison between a vectorization of the request and at least one of the one or more respective vectorizations of the subset of documents and based on a determination that the user associated with the tenant is permitted to access the subset of documents, and means for presenting a response to the generative AI prompt, the response generated by the one or more LLMs using the generative AI prompt.

A non-transitory computer-readable medium storing code for grounding a generative artificial intelligence (AI) prompt for a tenant of a multi-tenant database system is described. The code may include instructions executable by one or more processors to receive user input indicating a configuration that identifies one or more large language models (LLMs) configurable for the tenant and an indication of a subset of documents of a set of documents stored at the multi-tenant database system, the subset of documents indicated in the configuration as being available to the tenant for processing with the one or more LLMs, generate one or more respective vectorizations of content of each document of the subset of documents, receive, from a user associated with the tenant, a request to generate a generative response with the one or more LLMs, generate the generative AI prompt using the content of one or more documents of the subset of documents to ground the generative AI prompt, where the subset of documents is identified based on a comparison between a vectorization of the request and at least one of the one or more respective vectorizations of the subset of documents and based on a determination that the user associated with the tenant is permitted to access the subset of documents, and present a response to the generative AI prompt, the response generated by the one or more LLMs using the generative AI prompt.

Some examples of the method, apparatus, and non-transitory computer-readable medium described herein may further include operations, features, means, or instructions for storing configuration metadata including the indication of the one or more LLMs and the indication of the subset of documents, where generating the one or more respective vectorizations may be based on the configuration metadata, and where generating the generative AI prompt may be based on the configuration metadata.

In some examples of the method, apparatus, and non-transitory computer-readable medium described herein, the configuration metadata further includes an indication of one or more fields of the subset of documents, an indication of a quantity of the subset of documents whose content may be to be vectorized, an indication of a vectorization model, an indication of one or more specifications of the subset of documents, or any combination thereof.

In some examples of the method, apparatus, and non-transitory computer-readable medium described herein, the request indicates generation metadata indicating one or more fields of the one or more documents of the subset of documents, or any combination thereof and generating the generative AI prompt may be based on the generation metadata.

In some examples of the method, apparatus, and non-transitory computer-readable medium described herein, generating the one or more respective vectorizations of content may include operations, features, means, or instructions for transmitting, to the one or more LLMs, a first vectorization request to generate the one or more respective vectorizations of the content of each document of the subset of documents and receiving, from the one or more LLMs, the one or more respective vectorizations of the content.

In some examples of the method, apparatus, and non-transitory computer-readable medium described herein, generating the generative AI prompt may include operations, features, means, or instructions for transmitting, to the one or more LLMs, a second vectorization request to generate the vectorization of the request and receiving, from the one or more LLMs, the vectorization of the request.

Some examples of the method, apparatus, and non-transitory computer-readable medium described herein may further include operations, features, means, or instructions for storing access metadata including an indication of the subset of documents, an indication of one or more fields of the subset of documents, or any combination thereof, querying a central authentication service to produce an authentication result indicating that the tenant may be permitted to access the one or more of the subset of documents, the one or more fields, or any combination thereof, and where presenting the response to the generative AI prompt may be based on the authentication result.

Some examples of the method, apparatus, and non-transitory computer-readable medium described herein may further include operations, features, means, or instructions for generating the generative AI prompt may be based on a runtime context associated with the request to generate the generative response.

The following provides an overview of aspects of the present disclosure:

Aspect 1: A method for grounding a generative artificial intelligence (AI) prompt for a tenant of a multi-tenant database system, comprising: receiving user input indicating a configuration that identifies one or more large language models (LLMs) configurable for the tenant and an indication of a subset of documents of a set of documents stored at the multi-tenant database system, the subset of documents indicated in the configuration as being available to the tenant for processing with the one or more LLMs; generating one or more respective vectorizations of content of each document of the subset of documents; receiving, from a user associated with the tenant, a request to generate a generative response with the one or more LLMs; generating the generative AI prompt using the content of one or more documents of the subset of documents to ground the generative AI prompt, wherein the subset of documents is identified based at least in part on a comparison between a vectorization of the request and at least one of the one or more respective vectorizations of the subset of documents and based at least in part on a determination that the user associated with the tenant is permitted to access the subset of documents; and presenting a response to the generative AI prompt, the response generated by the one or more LLMs using the generative AI prompt.

Aspect 2: The method of aspect 1, further comprising: storing configuration metadata comprising the indication of the one or more LLMs and the indication of the subset of documents; wherein generating the one or more respective vectorizations is based at least in part on the configuration metadata; and wherein generating the generative AI prompt is based at least in part on the configuration metadata.

Aspect 3: The method of aspect 2, wherein the configuration metadata further comprises an indication of one or more fields of the subset of documents, an indication of a quantity of the subset of documents whose content is to be vectorized, an indication of a vectorization model, an indication of one or more specifications of the subset of documents, or any combination thereof.

Aspect 4: The method of any of aspects 1 through 3, wherein the request indicates generation metadata indicating one or more fields of the one or more documents of the subset of documents, or any combination thereof; and generating the generative AI prompt is based at least in part on the generation metadata.

Aspect 5: The method of any of aspects 1 through 4, wherein generating the one or more respective vectorizations of content further comprises: transmitting, to the one or more LLMs, a first vectorization request to generate the one or more respective vectorizations of the content of each document of the subset of documents; and receiving, from the one or more LLMs, the one or more respective vectorizations of the content.

Aspect 6: The method of any of aspects 1 through 5, wherein generating the generative AI prompt further comprises: transmitting, to the one or more LLMs, a second vectorization request to generate the vectorization of the request; and receiving, from the one or more LLMs, the vectorization of the request.

Aspect 7: The method of any of aspects 1 through 6, further comprising: storing access metadata comprising an indication of the subset of documents, an indication of one or more fields of the subset of documents, or any combination thereof; and querying a central authentication service to produce an authentication result indicating that the tenant is permitted to access the one or more of the subset of documents, the one or more fields, or any combination thereof; wherein presenting the response to the generative AI prompt is based at least in part on the authentication result.

Aspect 8: The method of any of aspects 1 through 7, wherein generating the generative AI prompt is based at least in part on a runtime context associated with the request to generate the generative response.

Aspect 9: An apparatus for grounding a generative artificial intelligence (AI) prompt for a tenant of a multi-tenant database system, comprising one or more memories storing processor-executable code, and one or more processors coupled with the one or more memories and individually or collectively operable to execute the code to cause the apparatus to perform a method of any of aspects 1 through 8.

Aspect 10: An apparatus for grounding a generative artificial intelligence (AI) prompt for a tenant of a multi-tenant database system, comprising at least one means for performing a method of any of aspects 1 through 8.

Aspect 11: A non-transitory computer-readable medium storing code for grounding a generative artificial intelligence (AI) prompt for a tenant of a multi-tenant database system, the code comprising instructions executable by one or more processors to perform a method of any of aspects 1 through 8.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for grounding a generative artificial intelligence (AI) prompt for a tenant of a multi-tenant database system, comprising:
receiving user input indicating a configuration that identifies one or more large language models (LLMs) configurable for the tenant and an indication of a subset of documents of a set of documents stored at the multi-tenant database system, the subset of documents indicated in the configuration as being available to the tenant for processing with the one or more LLMs;
generating one or more respective vectorizations of content of each document of the subset of documents;
receiving, from a user associated with the tenant, a request to generate a generative response with the one or more LLMs;
generating the generative AI prompt using the content of one or more documents of the subset of documents to ground the generative AI prompt, wherein the subset of documents is identified based at least in part on a comparison between a vectorization of the request and at least one of the one or more respective vectorizations of the subset of documents and based at least in part on a determination that the user associated with the tenant is permitted to access the subset of documents; and
presenting a response to the generative AI prompt, the response generated by the one or more LLMs using the generative AI prompt.

2. The method of claim 1, further comprising:
storing configuration metadata comprising the indication of the one or more LLMs and the indication of the subset of documents;
wherein generating the one or more respective vectorizations is based at least in part on the configuration metadata; and
wherein generating the generative AI prompt is based at least in part on the configuration metadata.

3. The method of claim 2, wherein the configuration metadata further comprises an indication of one or more fields of the subset of documents, an indication of a quantity of the subset of documents whose content is to be vectorized, an indication of a vectorization model, an indication of one or more specifications of the subset of documents, or any combination thereof.

4. The method of claim 1, wherein:
the request indicates generation metadata indicating one or more fields of the one or more documents of the subset of documents, or any combination thereof; and
generating the generative AI prompt is based at least in part on the generation metadata.

5. The method of claim 1, wherein generating the one or more respective vectorizations of content further comprises:
transmitting, to the one or more LLMs, a first vectorization request to generate the one or more respective vectorizations of the content of each document of the subset of documents; and
receiving, from the one or more LLMs, the one or more respective vectorizations of the content.

6. The method of claim 1, wherein generating the generative AI prompt further comprises:
transmitting, to the one or more LLMs, a second vectorization request to generate the vectorization of the request; and
receiving, from the one or more LLMs, the vectorization of the request.

7. The method of claim 1, further comprising:
storing access metadata comprising an indication of the subset of documents, an indication of one or more fields of the subset of documents, or any combination thereof; and
querying a central authentication service to produce an authentication result indicating that the tenant is permitted to access the one or more of the subset of documents, the one or more fields, or any combination thereof;
wherein presenting the response to the generative AI prompt is based at least in part on the authentication result.

8. The method of claim 1, wherein generating the generative AI prompt is based at least in part on a runtime context associated with the request to generate the generative response.

9. An apparatus for grounding a generative artificial intelligence (AI) prompt for a tenant of a multi-tenant database system, comprising:
one or more memories storing processor-executable code; and
one or more processors coupled with the one or more memories and individually or collectively operable to execute the code to cause the apparatus to:
receive user input indicating a configuration that identifies one or more large language models (LLMs) configurable for the tenant and an indication of a subset of documents of a set of documents stored at the multi-tenant database system, the subset of documents indicated in the configuration as being available to the tenant for processing with the one or more LLMs;
generate one or more respective vectorizations of content of each document of the subset of documents;
receive, from a user associated with the tenant, a request to generate a generative response with the one or more LLMs;
generate the generative AI prompt using the content of one or more documents of the subset of documents to ground the generative AI prompt, wherein the subset of documents is identified based at least in part on a comparison between a vectorization of the request and at least one of the one or more respective vectorizations of the subset of documents and based at least in part on a determination that the user associated with the tenant is permitted to access the subset of documents; and
present a response to the generative AI prompt, the response generated by the one or more LLMs using the generative AI prompt.

10. The apparatus of claim 9, wherein the one or more processors are individually or collectively further operable to execute the code to cause the apparatus to:
store configuration metadata comprising the indication of the one or more LLMs and the indication of the subset of documents;
wherein generating the one or more respective vectorizations is based at least in part on the configuration metadata; and
wherein generating the generative AI prompt is based at least in part on the configuration metadata.

11. The apparatus of claim 10, wherein the configuration metadata further comprises an indication of one or more fields of the subset of documents, an indication of a quantity of the subset of documents whose content is to be vectorized, an indication of a vectorization model, an indication of one or more specifications of the subset of documents, or any combination thereof.

12. The apparatus of claim 9, wherein:
the request indicates generation metadata indicating one or more fields of the one or more documents of the subset of documents, or any combination thereof; and
generating the generative AI prompt is based at least in part on the generation metadata.

13. The apparatus of claim 9, wherein, to generate the one or more respective vectorizations of content, the one or more processors are individually or collectively further operable to execute the code to cause the apparatus to:
transmit, to the one or more LLMs, a first vectorization request to generate the one or more respective vectorizations of the content of each document of the subset of documents; and
receive, from the one or more LLMs, the one or more respective vectorizations of the content.

14. The apparatus of claim 9, wherein, to generate the generative AI prompt, the one or more processors are individually or collectively further operable to execute the code to cause the apparatus to:
transmit, to the one or more LLMs, a second vectorization request to generate the vectorization of the request; and
receive, from the one or more LLMs, the vectorization of the request.

15. The apparatus of claim 9, wherein the one or more processors are individually or collectively further operable to execute the code to cause the apparatus to:
store access metadata comprising an indication of the subset of documents, an indication of one or more fields of the subset of documents, or any combination thereof; and
query a central authentication service to produce an authentication result indicating that the tenant is permitted to access the one or more of the subset of documents, the one or more fields, or any combination thereof;
wherein presenting the response to the generative AI prompt is based at least in part on the authentication result.

16. The apparatus of claim 9, wherein generating the generative AI prompt is based at least in part on a runtime context associated with the request to generate the generative response.

17. A non-transitory computer-readable medium storing code for grounding a generative artificial intelligence (AI) prompt for a tenant of a multi-tenant database system, the code comprising instructions executable by one or more processors to:
receive user input indicating a configuration that identifies one or more large language models (LLMs) configurable for the tenant and an indication of a subset of documents of a set of documents stored at the multi-tenant database system, the subset of documents indicated in the configuration as being available to the tenant for processing with the one or more LLMs;
generate one or more respective vectorizations of content of each document of the subset of documents;
receive, from a user associated with the tenant, a request to generate a generative response with the one or more LLMs;
generate the generative AI prompt using the content of one or more documents of the subset of documents to ground the generative AI prompt, wherein the subset of documents is identified based at least in part on a comparison between a vectorization of the request and at least one of the one or more respective vectorizations of the subset of documents and based at least in part on a determination that the user associated with the tenant is permitted to access the subset of documents; and
present a response to the generative AI prompt, the response generated by the one or more LLMs using the generative AI prompt.

18. The non-transitory computer-readable medium of claim 17, wherein the instructions are further executable by the one or more processors to:
store configuration metadata comprising the indication of the one or more LLMs and the indication of the subset of documents;
wherein generate the one or more respective vectorizations is based at least in part on the configuration metadata; and
wherein generate the generative AI prompt is based at least in part on the configuration metadata.

19. The non-transitory computer-readable medium of claim 18, wherein the configuration metadata further comprises an indication of one or more fields of the subset of documents, an indication of a quantity of the subset of documents whose content is to be vectorized, an indication of a vectorization model, an indication of one or more specifications of the subset of documents, or any combination thereof.

20. The non-transitory computer-readable medium of claim 17, wherein:
the request indicates generation metadata indicating one or more fields of the one or more documents of the subset of documents, or any combination thereof; and
generating the generative AI prompt is based at least in part on the generation metadata.
